(19) United States
(12) Patent Application Publication
(10) Pub. No.: US 2005/0158513 A1
(43) Pub. Date: Jul. 21, 2005

(54) Breathable elastic web

(75) Inventors: Andrew James Peacock, Terre Haute, IN (US); Jeffrey Alan Middlesworth, Wauconda, IL (US); Matthew John O'Sickey, Terre Haute, IN (US); Todd Richard Skochdopole, Terre Haute, IN (US); Tze Wan Pansy Chung, Fox River Grove, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: TREDEGAR FILM PRODUCTS CORPORATION

(21) Appl. No.: 11/080,549

(22) Filed: Mar. 16, 2005

Related U.S. Application Data
(63) Continuation-in-part of application No. 10/717,960, filed on Nov. 21, 2003.
(60) Provisional application No. 60/463,079, filed on Apr. 15, 2003.

(51) Int. Cl. B32B 3/10

(52) U.S. Cl. 428/136

(57) ABSTRACT

An elastic web that can be made breathable upon application of a tensile force such as would be encountered in certain applications, such as in absorbent articles and other hygienic or non-hygienic articles, and bandages is described. Breathability is achieved by insertion into the web of slits whose open area increases upon application of a force on the web acting along the major axis of said slits.

### CROSS REFERENCE TO RELATED APPLICATION

This application claims priority from provisional application 60/463,079 filed Apr. 15, 2003, the disclosure of which is incorporated by reference herein in its entirety. This application also claims priority from U.S. patent application Ser. No. 10/717,960, filed Nov. 21, 2003, and entitled: “Breathable Elastic Web,” the disclosure of which is incorporated by reference herein in its entirety.

### BACKGROUND

1. Field of the Invention

Various embodiments relate to an elastic web that can be made breathable upon application of a tensile force, such as might be encountered in certain applications. Specifically, the elastic web may be made breathable when used in, for example, diapers and other personal hygiene articles, and bandages, which typically result in application of a tensile force on the web.

2. Description of Related Art

Absorbent articles such as diapers, training pants or incontinence garments are required to provide a close, comfortable fit about the wearer and contain body exudates while maintaining skin health. Many conventional absorbent articles typically have employed fasteners that attach the waist sections of the articles around a wearer as well as various configurations of waist elastics, leg elastics, elasticized liners, and elasticized outer covers. The fasteners and elastic components have been employed to help produce and maintain the fit of the articles about the body contours of the wearer that can lead to improved containment and comfort.

Skin health is believed to be promoted by keeping the humidity of the air that is in contact with the skin low. In an attempt to reduce the humidity level within such absorbent articles, breathable polymer films have been employed as outer covers. The breathable films typically are constructed with pores to provide desired levels of liquid impermeability and air permeability. Other absorbent article designs have been arranged to provide breathable regions in the form of breathable panels or perforated regions in otherwise vapor-impermeable outer covers to help ventilate the articles.

Elastic materials that are intended for use in diapers and other disposable articles can be made breathable by making them with holes or three dimensional cones that permit air to pass through. For example, U.S. Pat. Nos. 6,303,208 and 5,733,628 to Pelkie (the '208 and '628 patents, respectively), the disclosures of which are incorporated herein by reference in their entirety, disclose permeable vacuum formed three dimensional elastic webs. The films disclosed in these patents are relatively thick, and the holes formed through the films may impact the structural integrity of the film.

U.S. Pat. No. 6,452,063, to Curro et al. (hereinafter referred to as the '063 patent), the disclosure of which is incorporated herein by reference in its entirety, discloses a 3-dimensional apertured elastic web having elongate apertures. The web is stretchable in a direction perpendicular to the major axis of the elongate aperture. While the '063 patent discloses porous, elastomeric webs with good stretching characteristics, the 3-dimensional webs have poor recovery.

The use of slits to provide apertures in a polymeric web following stretching of the web is disclosed in U.S. Pat. No. 3,985,599 to Lepoutre and Pieniak (hereinafter referred to as the '599 patent), the disclosures of which are incorporated by reference herein in their entirety. However, the '599 patent specifically provides for a means for permanently imparting stretch to a web in a way that produces permanently stretched ligaments that have increased tensile properties over the unstretched web. The '599 patent discloses that the presence of apertures as a result of this stretching is undesirable.

The description herein of certain disadvantages associated with known methods and materials is not intended to limit the scope of the embodiments of the present invention. Indeed, embodiments of the invention may incorporate one or more known methods, materials, and/or apparatus, without suffering from these disadvantages.

### BRIEF SUMMARY

Despite the attempts to develop materials for improved absorbent articles, there remains a need for materials that can provide elasticity and breathability, without sacrificing the physical properties that are necessary for the application in absorbent articles or their manufacture.

Various embodiments provide an elastic web that exhibits porosity when subjected to a tensile force that is acting substantially in the direction that the material generally would be subjected to in the application for which it is intended. The inventor has discovered that it is possible to manufacture webs that contain regions that contain slits, and that the presence of such slits has little or no effect on the tensile properties of the web when the tensile force is acting substantially in the direction that the material would be subjected to in the application for which it is intended. In addition, the webs can be manufactured to exhibit an unload force similar to the unload force of the unslitted web. Furthermore, these slits provide a mechanism for imparting porosity and hence breathability to the web when a tensile force is applied thereto. A product of certain embodiments is a slitted film that is unapertured in its relaxed state, but is rendered breathable when subjected to a tensile force. Apertures are a desirable feature of the stretched web in order that breathability be achieved.

According to one embodiment, the web comprises an elastic web into which is inserted by a slitting mechanism, a plurality of slits, a majority of them having their major axes oriented in such a direction that they are within 45° of a common direction. When a tensile force is applied to the web in the direction in which the major axes are pointed, the ligaments between the slits stretch and also neck, causing the slits to widen into apertures. The apertures then provide breathability to the web. The level of breathability increases with an increase in the elongation of the web.

According to another embodiment, the web is slitted in the manner described above, and has an unload force ratio (ratio of unload force of slitted film to unload force of unslitted film) that is greater than about 0.25. An additional embodiment encompasses a slitted web as described above, wherein the open area of the slitted web is less than 15%, when the slitted web experiences tensile forces substantially equivalent to those experienced during ordinary usage. Another embodiment includes an absorbent article including the slitted webs described herein, the slitted web forming at least a portion of a side panel and/or side tab.

The elastic web of an embodiment can be combined with one or more webs to provide a composite material having a soft texture that may be more useful or appealing in some applications. Such webs can be fibrous in nature, examples being nonwoven and woven materials. This embodiment includes a composite material that comprises the elastic web described previously and an additional web. The composite material may be prepared by laminating the webs together, coextrusion, or any other suitable method for making the composite material.

### BRIEF DESCRIPTION OF THE DRAWINGS

FIG. 1 depicts regions of slits in a continuous web surface.

FIG. 2 illustrates a continuous region of slits within which are discontinuous regions of web.

FIG. 3 illustrates examples of regions of slits that are continuous stripes.

FIG. 4 illustrates an example of a row of slits laid out in one row in one direction in the plane of the web.

FIG. 5 depicts an example of a common direction, in which regions of slits are laid out in parallel, non parallel, linear and non linear rows, but share a common direction in the plane of the web.

FIG. 6 illustrates a set of slits that are used to define the terms “slit length”, “absolute slit separation”, and relative slit separation.

FIG. 7 depicts slits that define the terms “absolute row separation” and “absolute row offset” for slits that are positioned in rows.

FIG. 8 illustrates a region of slits that are defined by the expression (1.5 in/1.0/0.33/0.5).

FIG. 9 reveals an example of a set of slits that are oriented such that their major axes are within a pre determined angle of a common direction.

FIG. 10 depicts a region of slits that has been subjected to a tensile force and shows regions that have been opened as a result of the applied force. The area of the regions can then be used to define an open area for the web.

### DETAILED DESCRIPTION

Previously known elastic webs that have pre-formed holes in them suffer from a disadvantage in that the presence of holes in such structures reduces the physical strength of the web, as measured for example by tensile properties such as strength and elongation at break. Consequently, the known apertured materials necessitate a thicker, and therefore more expensive, construction than would otherwise be sufficient for a non permeable elastic web. Such webs with pre-formed holes also suffer from the disadvantage that when they are subjected to tensile forces, the holes tend to close, thereby reducing their porosity and hence their breathability.

Another tensile property adversely affected by the formation of holes in an elastic web is its ability to grip, or fit an object. This property is referred to herein as the unload force. A drastic reduction in unload force, as seen with conventional apertured or slitted webs, seriously hinders their use as an elastic material. The present inventors discovered, however, that slitting a web in accordance with the teachings described herein does not result in a significant decrease in the unload force, when compared to an equivalent unapertured web.

Embodiments relate to breathable elastomeric webs that can be used alone, or as a composite, or preferably, a laminate construction with one or more support webs. It is to be understood that the terms “elastic” and “elastomeric” can be used interchangeably throughout this description.

The elastomeric web of an embodiment has an advantage over known breathable elastomeric products because breathability is imparted to the inventive web when a tensile force that is sufficient to elongate the web by more than about 10% is applied to the web. It also is to be understood that the terms “breathability” and “porosity” may be used interchangeably throughout this description. The breathability of the web is believed to increase up to a point, with a corresponding increase in elongation of the web, and the amount of elongation that is required to impart a desired level of breathability that is useful in certain applications is typical of the elongation that the web would be subjected to in those applications.

The webs of embodiments are useful in such applications as disposable diaper waistbands, fastening components (e.g., side tabs), side panels, wherein the web is subjected to a hoop stress as the diaper conforms to the waist of the wearer (e.g., baby or adult). The webs also may be used in a bandage, wherein a stress is imparted to the bandage in order to keep it attached to the body part that is being bandaged. These examples are not to be taken as exclusive applications for the webs of this invention, which would find application in any area where breathability under the influence of stress would be desirable.

Embodiments provide elastic materials that contain apertures and are breathable when stretched, and in particular, breathable when stretched by a tensile force acting in the direction of the force that the material would experience in end use conditions (e.g., in a diaper side tab that would normally experience the hoop stress of the diaper waist band when gripping the wearer's waist). Another example of stress in the direction of the force that the material would experience in end use conditions includes the stress that would be experienced by a bandage that is wrapped around a body part, or that is stretched and then adhered.

Embodiments also provide elastic materials that are breathable when stretched, but that retain essentially all of the physical properties of an unapertured web. Such materials do not suffer the disadvantage of the significant loss of physical properties normally associated with a web that is apertured, and hence made breathable by such processes as hot needle punching or vacuum forming.

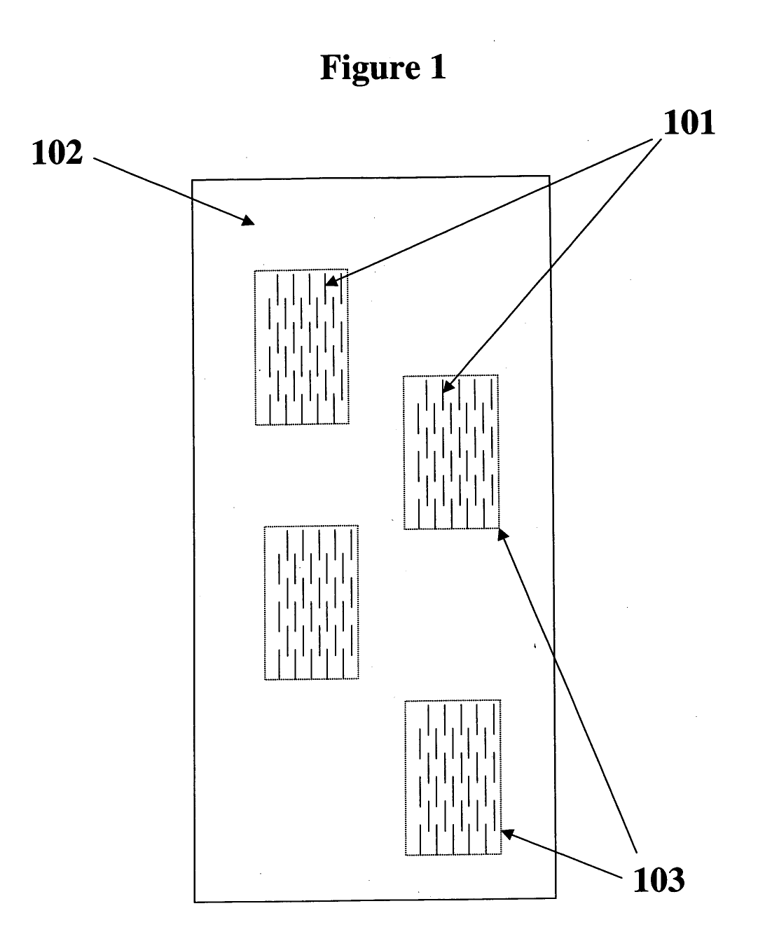

The embodiments can be understood by reference to the following definitions, and the FIGS. 1 to 10, as referenced below.

Throughout this description, the term “web” refers to a material capable of being wound into a roll. Webs can be film webs, nonwoven webs, laminate webs, apertured laminate webs, etc.

The expression “stretchable web” as it is used herein, denotes a web that can experience deformation when stress is applied to the web. A stretchable web may be stretchable either before or after slitting. Preferably, a stretchable web can be elongated to at least twice its gauge length without failure. More preferably, a stretchable web can be elongated to three times its gauge length without failure. Most preferably, a stretchable web can be elongated to more than 3.5 times its gauge length without failure.

The term “essentially” when used to describe a property of the invention is taken to mean that the property can deviate by ±(plus or minus) 10% of its stated value. In the case of an angle between two directions, the term “essentially” means within ±10° of the stated angle.

Throughout this description, the expressions “unapertured film” or “unapertured web” refers to films or webs that have not had holes, apertures, pores or slits inserted in it for the purpose of making it breathable to air or water vapor, without application of a tensile force. The term “breathable” in the context of the present disclosure means having a porosity of at least about 1.0 (m³/m²/min) when tested under the conditions specified in the section entitled “Porosity Testing.”

As used herein, the term “elastic” is used to describe a material that upon application of a tensile force is extensible to a stretched length, preferably at least 100% of its initial, unstretched length, and that exhibits a recovery of more than 25% according to:
Recovery (%)=100×(Ls−Lf)/(Ls−Lo)
Where:
Lo=initial length
Ls=stretched length
Lf=final length

As used herein, a “slit” is defined as an elongated hole having major and a minor axes. The ratio of the length of the major to the minor axis is the aspect ratio of the slit, which in various embodiments is preferably greater than 5.0, and more preferably greater than 10.0 and even more preferably greater than 20.0, and most preferably greater than 100.0. Individual slits in the stretchable web may be the same or different lengths, and may have the same or different aspect ratio.

As used herein, a slit may have linear or non-linear sides, which may or may not be parallel with each other. Examples of non-linear sides include curved or wavy lines. Alternatively, the slit may have sides comprising two or more linear or curved segments that meet at acute or obtuse angles.

As used herein, the term “number density” refers to the number of slits per square inch in the regions of the web surface.

According to one embodiment, the web comprises a top surface and a bottom surface with one or more regions having a plurality of slits. The web comprises a stretchable web into which is inserted by a slitting mechanism, a plurality of slits, the majority of them having their major axes oriented in such a direction that they are within 45° of a common direction on the web surface. In another preferred embodiment of the web, the slits are aligned each with their major axes oriented at an angle within 30° of a common direction on the web surface. In yet another preferred embodiment, the slits are aligned each with their major axes oriented at an angle within 15° of a common direction on the web surface. In a preferred embodiment of the web, the slits are aligned each with their major axes essentially parallel to a common direction on the web surface. In a preferred embodiment of the web, the lengths of the major axes of the slits are in the ranges of about 0.25 to about 25 mm. In other preferred embodiments, the lengths of the major axes of the said slits are between about 1.25 and about 12.5 mm and between about 2.5 and about 6.25 mm.

According to one preferred embodiment of the web, the slits have an aspect ratio (i.e., the ratio of major axis to minor axis) greater than about 25, and all of their major axes are pointed in essentially the same direction. In a preferred embodiment, the slits are characterized by a major and minor axes, the ratio of the major axis to minor axis (aspect ratio) being more than about 5. When a tensile force is applied to the web in the direction where the major axes are pointed, the ligaments between the slits stretch and also neck, causing the slits to widen into apertures. The slits also open when a tensile force is applied to the web along the common direction. The apertures then provide breathability to the web. The level of breathability increases with an increase in the elongation of the web.

In a more preferred embodiment of the web, the slits are organized into regions on the web surface. These regions have boundaries, outside of which slits cannot be found on the web surface except inside another region. One or more regions can be found on a web surface. In a preferred embodiment, the regions are located at positions on the web surface where it is desired that the web be stretchable and breathable. The common direction to which the slits in each region are aligned may vary from region to region. In addition, the web can be fabricated with a slitting means providing in-line slitting capability such that the number and orientation of slits, as well as the respective slits' aspect ratios, may be varied as desired.

Within the slitted regions, the slits may be arranged in a regular or irregular array, preferably a regular array that can be characterized by four parameters that describe the size of a slit and its position relative to other slits in the array. In an embodiment of the web, the arrangement of slits within any one or more of the regions is organized in an array, the array comprising rows of slits that are essentially parallel in their major axes, the rows being characterized by the slit length (SL), the relative slit separation (SS), the relative row separation (RS), and the relative row offset (RO). In another embodiment of the web, the array of slits within any one of the regions is arranged independently of the arrangement of the arrays of slits in the other regions.

Some preferred embodiments have a density and size of slits that is appropriate for the application for which the web is intended. For example, for a diaper waistband application, the slit length (SL) may be in the range of 0.25 to 25 millimeters (mm), and more preferably 1.25 to 12.5 mm, and most preferably 2.5 to 6.25 mm. In a preferred embodiment of the web, the array has a hexagonal symmetry such that the relative row offset value RO=SS/2. In another preferred embodiment, the array has a rectangular symmetry such that the relative row offset value RO=0 (zero). In yet another preferred embodiment, the array has a staggered configuration such that the relative row offset value (RO) is not equal to SS/2. In another preferred embodiment of the web, the relative row separation of the array (RS) is between −0.9 and 10.0. In other preferred embodiments, the relative row separation of the array (RS) is between −0.25 and 2.0. In a preferred embodiment, the relative row offset value (RO) is less than 0.5. In another preferred embodiment the relative row offset value (RO) is less than 0.25.

In another embodiment of the web, the slits are positioned randomly within any one or more of said regions in the web. The major axes of the slits may be oriented randomly in the plane of the web, although all of the slits preferably fall within 45° of a common direction. The effectiveness of this embodiment is not entirely dependent on the regularity of the arrangement of the slits in a region, and a random array will suffice to provide the benefits described herein.

According to another embodiment of the web, the number density of slits per square inch within any one or more of the slitted regions is between 5 and 1,000. In another embodiment of the web, the number density of slits per square inch within any one or more of the slitted regions is between 10 and 500. In other embodiments of the web, the number density of slits per square inch within any one or more of the slitted regions is between 20 and 100.

In another embodiment of the web, the total length of slits per square inch within any one or more of the slitted regions is between 0.5 and 50 inches/square inch. In another embodiment, the total length of slits per square inch within any one or more of the slitted regions is between 1 and 25 inches/square inch. Yet, in another embodiment, the total length of slits per square inch within any one or more of the slitted regions is between 2.0 and 10 inches/square inch.

In a preferred embodiment, the slitted webs have an unload force ratio, (the ratio of the unload force of the slitted web versus the unload force of the same web that is unslitted), of greater than about 0.25, more preferably greater than about 0.5, even more preferably, greater than about 0.6, and most preferably, from about 0.6 to about 1.25, and from 0.6 to about 1.0. It is preferred that the unload force be measured at 30% strain during relaxation after being cycled twice to 200%. The embodiments described herein have such an unload force ratio, when a tensile force is applied in the common direction. In contrast, when a tensile load is applied in a direction transverse to the common direction, which will open the slits as disclosed in the art, the unload ratio is less than 0.25, and typically, less than 0.15.

Elastomeric materials that are useful as a material of construction of the elastic web include polyolefin type materials such as polyethylene elastomers and polyurethane webs. In certain embodiments, the preferred elastomeric web material is capable of achieving essentially full recovery after being stretched at least about 300 to about 400% of its original length. Suitable stretchable elastomeric webs comprise natural polymeric materials and synthetic polymeric materials. Suitable elastomeric webs include isoprenes, butadiene-styrene materials, styrene block copolymers such as styrene/isoprene/styrene (SIS), styrene/butadiene/styrene (SBS), or styrene/ethylene-butene/styrene (SEBS) block copolymers. Blends of these polymers alone or with other modifying elastic or non-elastomeric materials are also contemplated for being useful with the embodiments. In certain embodiments, the elastomeric materials can comprise high performance elastomeric materials such as Kraton™ elastomeric resins from Kraton Polymers that are elastomeric block copolymers.

The elastic web of an embodiment can be combined with one or more webs to provide a soft texture that may be more useful or appealing in some applications. Such webs can be fibrous in nature, and/or preferably are nonwoven and woven materials. This embodiment includes a composite material that comprises the elastic web having slits, as described previously, and an additional web. The composite material may be prepared by laminating the webs together, coextrusion, or by any other suitable method for making the composite material.

Examples of methods of making laminates of elastomeric materials and other webs are disclosed in U.S. Pat. Nos. 6,475,600, 5,156,793, and 5,422,172, the disclosures of each of which are incorporated herein by reference in their entirety. The '600 patent discloses a breathable composite material formed from at least one layer of an elastic material and a necked laminate of sheet layers. The breathable laminate is made by first partially stretching a filled non-elastic film layer, attaching a non-elastic neckable layer to form a laminate and then stretching the laminate to neck the laminate and lengthen the film to its desired fully stretched configuration. The '793 patent discloses a “zero strain” stretch laminate web exhibiting a non-uniform degree of elasticity, as measured in the direction of elasticization at various points along an axis oriented substantially perpendicular to the direction of elasticization. The “zero strain” stretch laminate material is formed of at least two piles of material that are ether intermittently or substantially continuously secured to one another along at least a portion of their coextensive surfaces while in a substantially untensioned condition. The '172 patent discloses an elastic laminated sheet of an incrementally stretched nonwoven fibrous web and an elastomeric film that have properties of stretchability and recoverability. The laminate is made by the method of extrusion or adhesion of the nonwoven fibrous web to the elastomeric film. Those skilled in the art are capable of making a composite material from the slitted elastic web and another web, using the guidelines provided herein.

When used in an absorbent article, it is preferred that the web (or composite or laminate of the web and another material) be used as a component that enables the absorbent article to stretch and maintain a snug fit. Preferably, the slitted webs are utilized as side panels, waistbands, and securement or attachment tabs (those containing tape or hook-and-loop fasteners), and most preferably in areas of the article that typically encounter elongation more than about 20%, preferably more than about 25%. In addition, the webs, or composites or laminates thereof, can be used in bandages in areas that are subjected to elongation of more than about 20%, preferably more than about 25%, such as the adhesive area or the absorbent pad.

Turning now to the figures, a slitted region, or region of slits, of the web's surface is taken to be an area where a multiplicity of slits can be found. The slitted region can be discrete, and provide the appearance of an island or islands in an otherwise continuous web surface. An example of such an arrangement of slits is shown in FIG. 1, which is to be understood as an example, and not to limit the possible arrangements of slits or regions that represent various embodiments. In FIG. 1, a web (102) comprises regions (103) each of which comprise a plurality of slits (101). The regions (103) are depicted as bounded by dotted lines, for the sake of demonstrating the boundaries of said regions. The dotted lines are not to be construed as constructs on the web. In the example of FIG. 1, the unapertured regions of the web (102) form a continuous surface where the regions may appear as “islands.”

The slits in the regions shown in FIG. 1 can be seen to be arranged in a regular array, where rows of slits form a hexagonal array. It should be understood that the effectiveness of this embodiment is not dependent on the regularity of the arrangement of the slits in a region, and a random array will suffice to provide the benefits described herein.

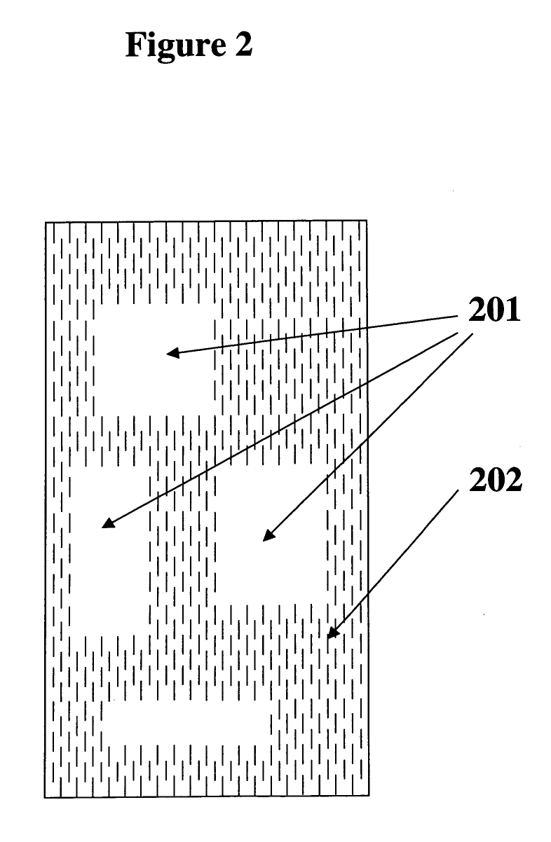

FIG. 2 illustrates an example of how the slitted region can be continuous in a given sample, with unslit regions (201) that provide the appearance of islands in a continuous region of slits (202). Again, FIG. 2 is to be understood as an example and not to limit the possible arrangements of slits or regions that represent embodiments.

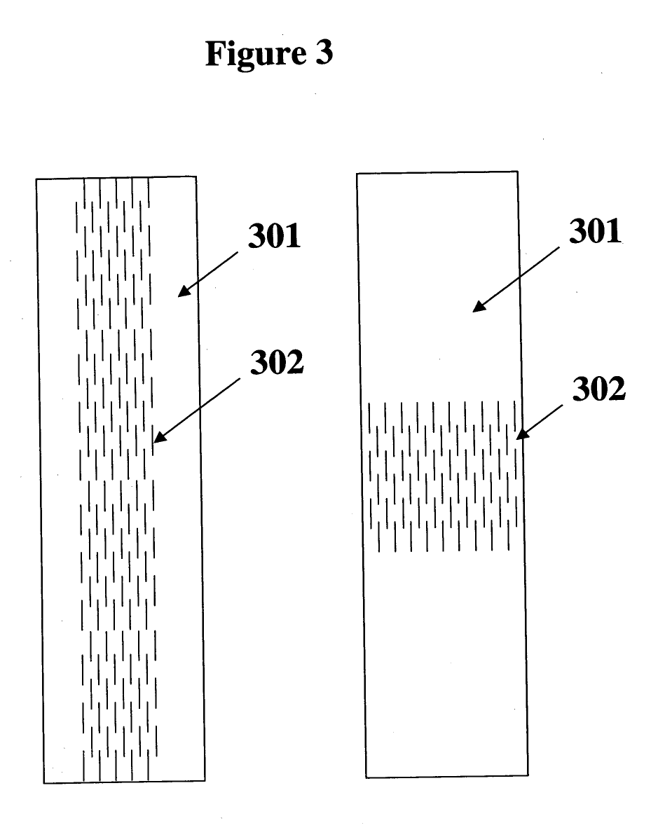

Alternatively, the slitted region can be viewed as one or more continuous stripes along the length or across the width of a web, as presented schematically in FIG. 3. In FIG. 3, continuous striped slit regions (302) are shown in an otherwise unslit web (301).

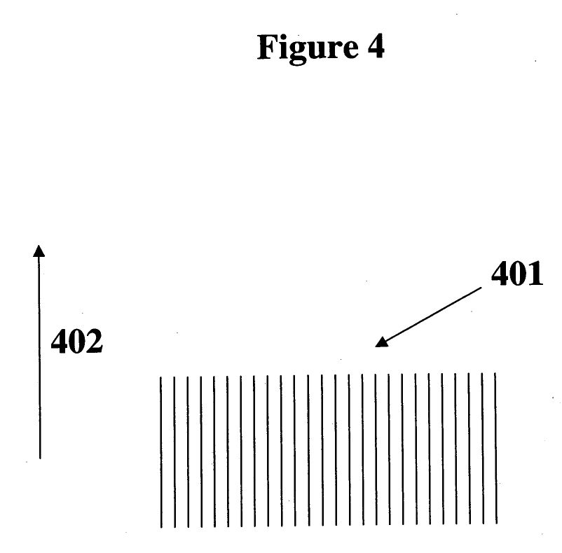

A “row of slits” is defined as in FIG. 4, where a region is laid out in a row in one direction of the web. The slits (401) in FIG. 4 are laid out with their major axes in a common direction (402).

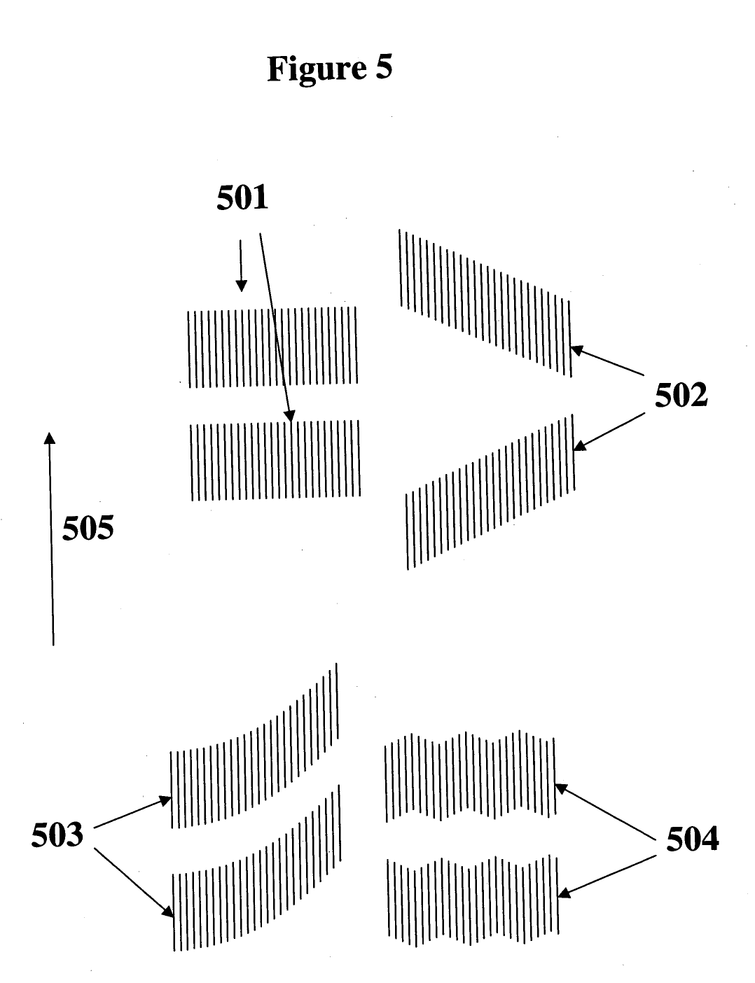

A “striped pattern” is depicted in FIG. 5, where regions of slits are laid out in parallel (501 and 503), or non-parallel (502 and 504), linear (501 or 502) or non-linear (503 or 504) rows sharing a common direction (505) in the plane of the web. In each of the four examples of patterns shown in FIG. 5, the major axes of the slits share a common direction (505).

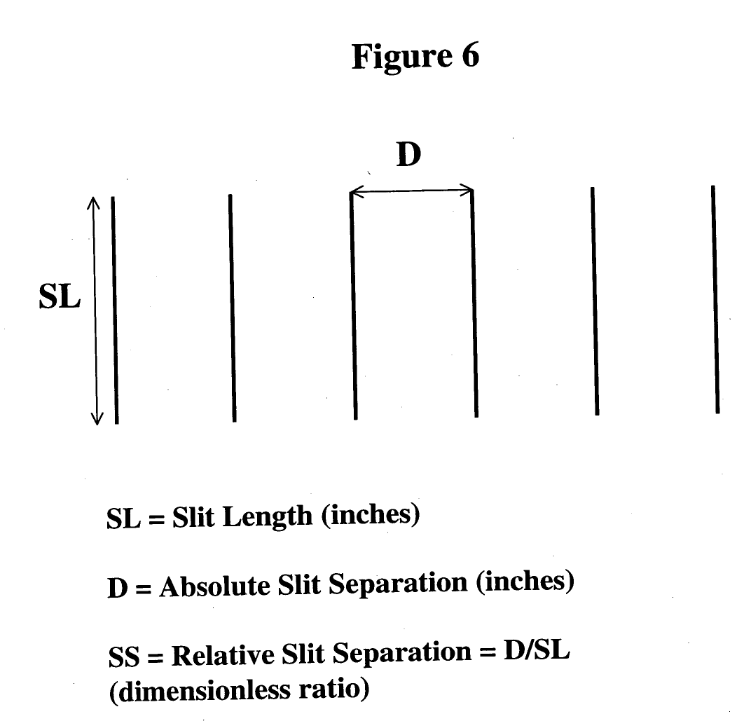

The expressions “slit length” (SL) and “absolute slit separation” (D) refer to dimensional parameters of the slit regions of the web of the invention, and can be understood more fully by reference to FIG. 6. These definitions are understood to be applicable to any row of slits where SL is the length of the slit in inches, D is the absolute slit separation in inches, and the dimensionless “relative slit separation” (SS) is equal to D/SL.

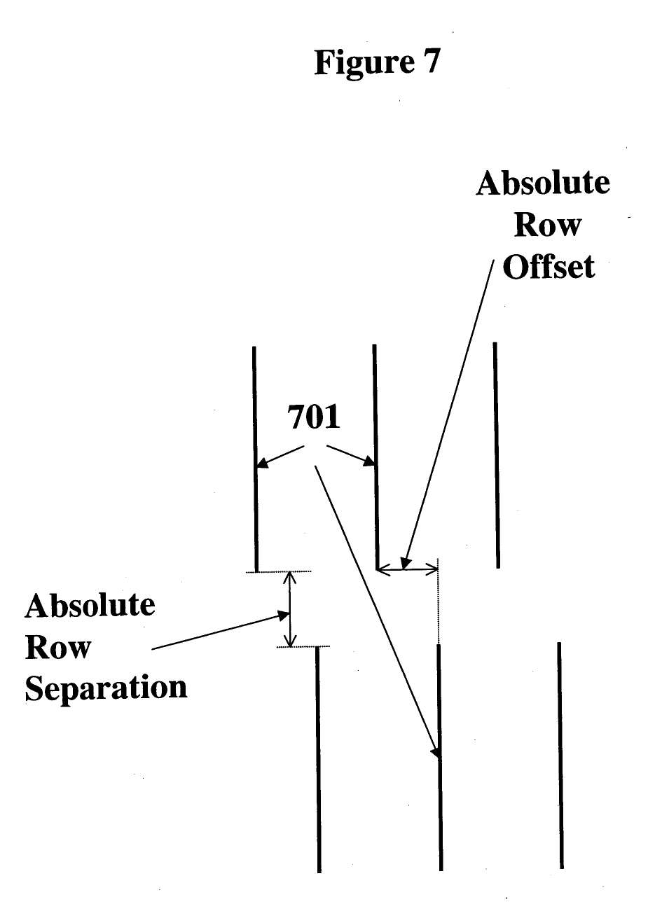

The expressions “absolute row separation” and “absolute row offset” refer to dimensional parameters of the slit regions of the web of the invention where slits can be identified as being positioned in adjacent rows. These expressions can be better understood by reference to FIG. 7, where they are defined for the set of slits (701) illustrated therein.

The expressions “absolute row separation” (ARS) and “absolute row offset” (ARO) can be used to define parameters that can be further applied to any set of slits arranged in adjacent rows. For the purpose of characterizing such a set of slits, the expression “relative row separation” (RS) is defined as the measured absolute row separation divided by slit length (SL). The expression “relative row offset” (RO) is equal to the absolute row offset between rows divided by the absolute slit separation (D).

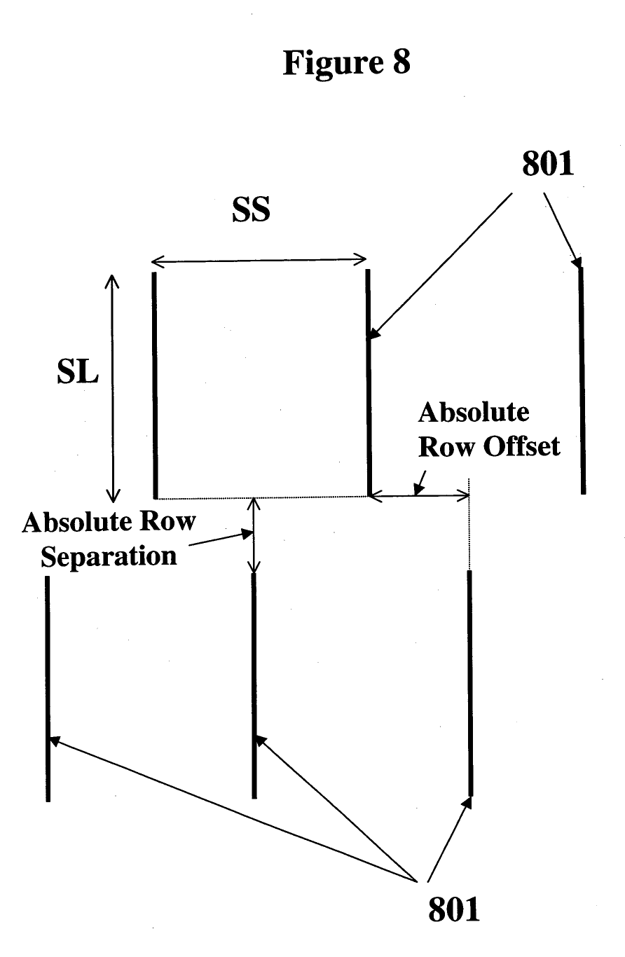

A region of slits in a web can therefore be characterized by four numbers, SL/SS/RS/RO, the latter three numbers of which are dimensionless. This terminology will be used when describing examples of this invention. For example, the terminology 1.5 in./1.0/0.33/0.5 refers to the slit pattern that is depicted in FIG. 8:
SL=1.5 in;
SS=D/SL=1.0 (=1.5 in/1.5 in);
RS=ARS/SL=0.33 (=0.5 in/1.5 in); and
RO=ARO/SL=0.5 (=0.75 in/1.5 in).

It is to be understood that FIG. 8 may not be drawn to scale, but rather is a schematic representation of a slit region in which the slit length (SL), absolute slit separation (D), the absolute row separation, and the absolute row offset are in the ratios specified to the slit length in the example.

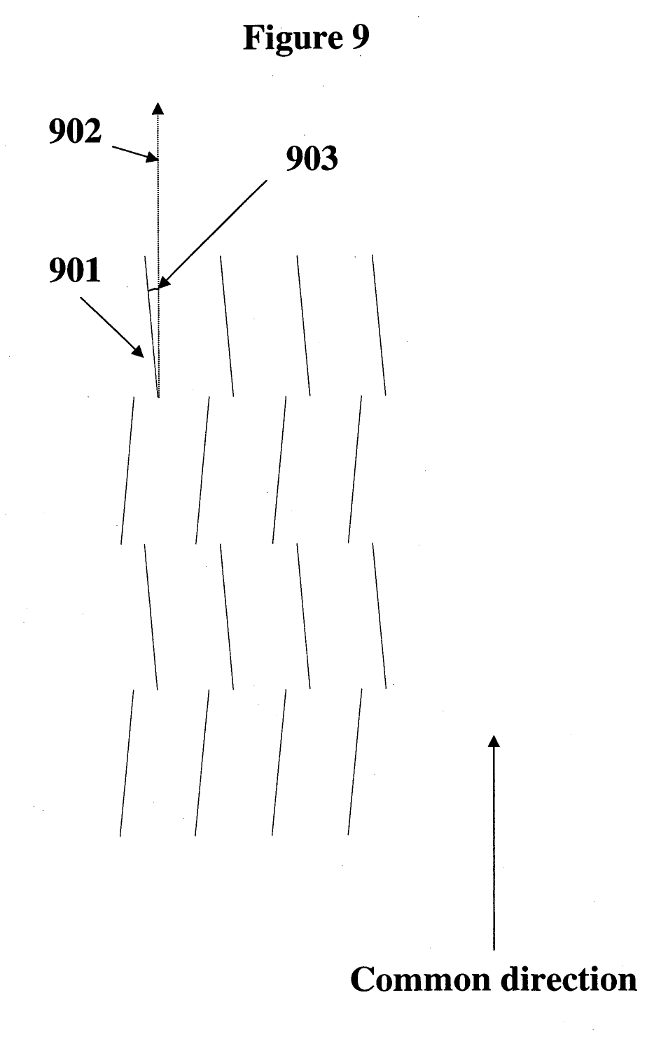

The expression “common direction” as it is used throughout this description denotes any direction in the plane of the web, with respect to which an angle with the major axis of each individual slit can be measured. For example, if the orientation of the major axes of all slits is no more than +/−10° from a common direction, the common direction can be found in the plane of the web that is pointed no more than 10° from the directions of the major axes of all of the slits in the region. FIG. 9 illustrates an example of a common direction (904) of the region of slits. A slit (901) has an angle (903) to a direction (902). The direction (902) also makes an angle to all of the other major axes of the slits in the region and can be defined by the maximum angle of the set of all angles it makes with all of the slits. The common direction is the direction in which the angle (903) of the major axes of the slits varies by only 5°.

The term “randomly” when used to describe the positioning of slits in the plane of the web refers to the fact that no discernable regular pattern, for example rectangular, hexagonal, etc., can be seen in the way that slits are arranged in the surface of the web.

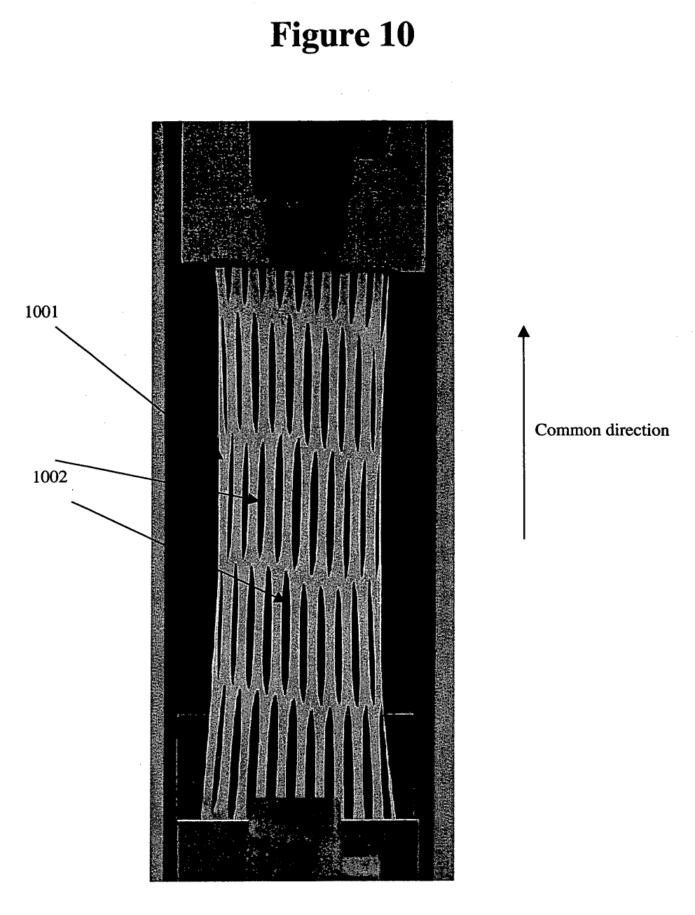

The expression “open area” of a region of slits is reported as a percentage (%) and is better understood by reference to FIG. 10, where the area of web that has opened in the plane of the web is seen as a black space in the photograph. The expression “open area” is accordingly the area of space seen as black (1002) in a photograph of the web divided by the total area of web in the slit region. The present inventor believes that it is difficult to correlate open area with film or web porosity, due in part to the dependence of the latter on pore size and shape, as well as the web thickness. For the intended uses, an open area of about 1% is sufficient to induce porosity that is above the levels of breathability in structures that are considered “breathable.” A minimum open area of about 0.5%, and preferably about 1% therefore is a useful practical lower limit on a preferred structure. In an embodiment, the web has an open area of greater than 1% when stretched to 100% elongation. In a preferred embodiment, the web has an open area of less than about 25%, more preferably less than about 15%, more preferably, from about 1% to about 15%, and most preferably from about 1% to about 10%, when stretched to 100% elongation.

The term “reversibly” in the context of embodiments denotes that upon application of a tensile force, the porosity of the web will increase, and upon removal of the tensile force, the porosity of the web will decrease. It is preferred that such increases and decreases in porosity will occur repeatedly in response to corresponding stretching and relaxing of the web through at least 20 cycles, and more preferably at least 50 cycles.

The term “nonwoven” in the context of embodiments preferably denotes a web comprising a multitude of fibers. The fibers can be bonded to each other or can be unbonded. The fibers can be staple fibers or continuous fibers. The fibers can comprise a single material or can comprise a multitude of materials, either as a combination of different fibers or as a combination of similar fibers each comprised of different materials.

The nonwoven web useful in one embodiment can be the product of any process for forming the same. Examples of known methods for manufacturing nonwoven webs include the processes that produce spun bond and melt blown nonwoven webs. The nonwoven web useful in various embodiments may be any of the known nonwoven webs, or it may be a composite or combination of webs, such as spun bond or melt blown webs. In one embodiment, the web is a spun bond material, made of polypropylene fiber. Those skilled in the art will appreciate that the nonwoven web may be any polymeric material from which a fiber can be produced.

For a nonwoven web to be extensible in any given direction means that when a tensile force is applied to the web in that direction, the web expands in that direction, and a strain is induced in the web, preferably, although not necessarily, without substantial breakage of fibers or undue distortion of the web structure.

The composite materials useful in various embodiments include a fibrous web (e.g., a nonwoven web) bonded to slitted material. Bonding can be accomplished by any of the several known mechanisms for bonding that include, but are not limited to, adhesive lamination, thermal lamination and vacuum lamination. In one embodiment, the nonwoven can be slitted to match the pattern of slits in the slit web to which it is attached. In another embodiment, the nonwoven can be slitted in a pattern that does not match the pattern of slits in the slitted web to which it is attached.

The expression “adhesive lamination” refers to a process by which two web surfaces are bonded to each other by the application of adhesive, and optionally heat, to one or both of the webs, in a regular or random pattern. Sufficient pressure is applied to the surfaces in contact with each other that they remain affixed to each other when the pressure is removed.

The expression “thermal lamination” refers to a process by which two web surfaces are bonded to each other by the application of heat and pressure, such that the surfaces remain affixed to each other when the pressure is removed.

The expression “vacuum lamination” refers to a process by which two web surfaces are bonded to each other by the application of heat and vacuum, the vacuum being applied against one of the surfaces. One of the webs may be a molten curtain of polymer, from which the heat is removed by a screen or roll as the lamination with the other web proceeds.

The expression “absorbent article,” as used herein, refers to articles that absorb and contain liquid or semi-solid materials. More specifically, the expression refers to articles that are placed against or in proximity to the body of a wearer to absorb and contain the various exudates discharged from the body. The expression “absorbent article” is intended to include diapers, incontinent articles, sanitary napkins, pantiliners, medical drapes, carpal tunnel bandages, wipes, and other hygienic or non-hygienic articles used to absorb body fluids. The term “disposable” refers to articles that are intended to be discarded after a single use and preferably recycled, composted, or otherwise disposed of in an environmentally compatible manner, i.e., they are not intended to be laundered or otherwise restored or reused as an absorbent article.

The term “diaper” refers to a garment generally worn by infants and incontinent persons that is drawn up between the legs and fastened or otherwise secured about the waist of the wearer. Examples of diapers are disclosed in U.S. Pat. Re. No. 26,152 and U.S. Pat. Nos. 3,860,003, 4,610,678, 4,673,402, 4,695,278, 4,704,115, 4,834,735, 4,888,231, and 4,909,803. The disclosures of these patents are incorporated by reference herein in their entirety.

The expression “incontinence article” refers to pads, undergarments (pads held in place by a suspension system of same type, such as a belt, or the like), inserts for absorbent articles, capacity boosters for absorbent articles, briefs, bed pads, and the like, regardless of whether they are worn by adults or other incontinent persons. Examples of incontinence articles are disclosed in U.S. Pat. Nos. 4,253,461, 4,597,760, 4,704,115, 4,909,802, and 4,964,860. The disclosures of these patents are incorporated herein by reference in their entirety.

The expression “sanitary napkin” refers to an article that is worn by females adjacent to the pudendal region that is intended to absorb and contain various exudates that are discharged from the body (e.g., blood, menses, and urine). Examples of sanitary napkins are disclosed in U.S. Pat. Nos. 4,285,343, 4,589,876, 4,687,478, 4,917,697, 5,007,906, 4,950,264, and 5,009,653. The disclosures of these patents are incorporated by reference herein in their entirety.

The expression “medical drapes” refers to articles commonly used to cover the patient during medical procedures, exposing to the doctors and nurses only areas of the patient requiring attention. Medical drapes also are used to cover areas and stations where health care workers work and retrieve instruments such as back tables and Mayo stands. Conventional medical drapes typically comprise non-woven materials or nonwovens attached to plastic sheets. Examples of medical drapes are disclosed in U.S. Pat. Nos. 6,279,578, 5,492,751, 5,445,165, 5,188,885, and 4,467,013. The disclosures of these patents are incorporated herein by reference in their entirety.

The expression “protective apparel” refers to garments and accessories that are worn to provide certain protective measures to the wearer. For example, protective apparel may protect against bodily contact with infectious or caustic fluids. Protective apparel may be in the form of garments such as shirts, pants, robes, and other garments. Protective apparel also may be in the form of accessories such as shoes, gloves, face masks, hair coverings, and other accessories. Examples of protective apparel are disclosed in U.S. Pat. Nos. 6,596,658, 6,557,497, and 6,155,084. The disclosures of these patents are incorporated herein by reference in their entirety.

The expression “carpal tunnel bandages” refers to bandages and wraps used to partially or fully immobilize the wrists of persons experiencing carpal tunnel syndrome. Immobilizing the wrist is thought to relax wrist and arm muscles that might otherwise pinch the median nerve, which runs the length of the arm and wrist into the hand. Examples of carpal tunnel bandages are disclosed in U.S. Pat. Nos. 6,776,769, 6,506,175, 6,293,919, and 5,036,838. The disclosures of these patents are incorporated herein by reference in their entirety.

In certain embodiments, the above referenced absorbent article, disposable diaper, elastic bandage, incontinence article, sanitary article, medical drape, protective apparel, and carpal tunnel bandage each may comprise the webs described herein. Webs of embodiments also may be included in non-hygienic applications, as will be appreciated by one skilled in the art.

### EXAMPLES

### Hysteresis and Tensile Strength Testing

A sample of embossed elastic film was prepared by casting a molten web against a metal screen. The sample then was slit in three configurations using a hobby knife equipped with interchangeable blades. The unapertured film had a total gauge thickness of 3.13 mils. The slit regions encompassed the entire area of the film between the grips of a tensile tester (model Synergie 200 from MTS, Eden Prairie, Minn.).

For the purposes of understanding the data in table 1, “load at 200% strain cycle 1” is the load sustained by a sample 50.8 mm wide with a gauge length of 31.75 mm after being stretched to 200% strain at 317.5 mm/minute.

“Load at 30% strain upon recovery cycle 2” is the load sustained by a sample 50.8 mm wide with a gauge length of 31.75 mm after being stretched to 200% strain at 317.5 mm/minute, at which extension it is held for 30 seconds, and then allowed to relax at 317.5 mm/minute to 0% extension at which it is held for 60 seconds and then stretched to 200% strain at 317.5 mm/minute at which extension it is held for 30 seconds, then allowed to relax at 317.5 mm/minute, and the load at 30% strain noted.

“Force relaxation during cycle 2 hold” is obtained after stretching a sample that is 50.8 mm wide with a gauge length of 31.75 mm to 200% strain at 317.5 mm/minute at which extension it is held for 30 seconds. It is then allowed to relax at 317.5 mm/minute to 0% extension at which it is held for 60 seconds and then stretched to 200% strain at 317.5 mm/minute at which extension it is held for 30 seconds. The measured force relaxation is the drop in load at the end of the 30 seconds hold relative to the load measured at the start of the hold period.

“Set cycle 2” is obtained after stretching a sample that is 50.8 mm wide with a gauge length of 31.75 mm to 200% elongation at 317.5 mm/minute, at which extension it is held for 30 seconds and then allowed to relax at 317.5 mm/minute to 0% extension at which it is held for 60 seconds, and then stretched at 317.5 mm/minute. The permanent set is the elongation of the sample at which the load cell detects a measurable load on the second extension.

One of the many advantages of certain embodiments of the present invention is the ability to retain most or even essentially all of the physical properties of an unapertured film. The following Table 1 shows the effect of slitting on the hysteresis properties of the film.

TABLE 1

| | | Slit film: | | Slit film: |
|---|---|---|---|---|
| | | staggered | Slit film: | overlapping |
| | Unslit | array | long slits | chisel cut array |
| | precursor | 0.2 | SL = 1.0 in | 0.236 in./0.85/ |
| | film | in./1/0/0.5 | SS = 0.2 in | −0.15/0.5 |
| Load at 200% | 6.57 | 6.50 | 6.53 | 6.45 |
| strain cycle | | | | |
| 1 (N) | | | | |
| Load at 30% | 0.13 | 0.09 | 0.08 | 0.09 |
| strain upon | | | | |
| recovery cycle | | | | |
| 2 (N) | | | | |
| Force relaxation | 16.4 | 16.8 | 16.4 | 16.6 |
| during cycle 2 | | | | |
| hold (%) | | | | |
| Set cycle 2 (%) | 15.0 | 15.8 | 15.9 | 15.8 |

Specimen width = 50.8 mm.
Specimen gauge length = 31.75 mm.
“N” = Newtons.

The slit films all retained the load handling capability of the unslit film up to 200% elongation, with an increase in set on the second cycle of at most 0.9% on a base set for unslit film of 15.0%. In addition, the ratio of unload force, (or load at 30% strain upon recovery cycle 2—“unload force ratio”), of the slitted webs relative to the unslit precursor film ranged from 0.08/0.13 to 0.09/0.13, or ratios of about 0.6 to about 0.7. This reveals that the slitted webs prepared in accordance with embodiments had excellent unload force when compared to the unslitted precursor film. The unload force of an elastomeric web is one of the parameters useful in determining how well the elastic material fits. Thus, slitted webs made in accordance with the invention do not suffer a significant decrease in the unload force, when compared to an identical unslitted web.

The tensile properties of various arrays described in table 2 are provided in Tables 3-5. The slitted region encompasses the entire area of the film in these examples. The precursor film was identical to the precursor film used in the embodiment whose results are provided in table 1.

TABLE 2

| Slit Patterns | Slit Configurations |
|---|---|
| Short slits | 0.2″/1.0/0.5/0.5 |
| Long slits | Slits 1″ long with 0.2″ separation |
| Rectangular array | 0.2″/1.0/0.5/0.0 |
| Staggered array | 0.2″/1.0/0.0/0.5 |
| Overlapping array | 0.2″/1.0/−0.25/0.5 |

Tensile properties (peak load, strain at break and load at various strains from 5% to 500%) were determined by using line grips to stretch a specimen that was 50.8 mm wide and with a gauge length of either 25.4 mm or 31.75 mm at an elongation rate equivalent to 1000% of the initial gauge length per minute.

TABLE 3

| | | | Compared to | | Compared to |
|---|---|---|---|---|---|
| | Precursor | Short | precursor | Long | precursor |
| | film | slits | film | slits | film |
| Peak load | 49.5 | 46 | 92.9% | 39.4 | 79.6% |
| (N) | | | | | |
| Strain at | 946 | 910 | 96.2% | 846 | 89.4% |
| break (%) | | | | | |
| Load at 5% | 1.91 | 1.75 | 91.6% | 1.52 | 79.6% |
| strain (N) | | | | | |
| Load at 10% | 3.47 | 3.32 | 95.7% | 3.14 | 90.5% |
| strain (N) | | | | | |
| Load at 15% | 4.32 | 4.20 | 97.2% | 4.07 | 94.2% |
| strain (N) | | | | | |
| Load at 50% | 5.56 | 5.40 | 97.1% | 5.49 | 98.7% |
| strain (N) | | | | | |
| Load at | 5.85 | 5.82 | 99.5% | 5.73 | 97.9% |
| 100% strain | | | | | |
| (N) | | | | | |
| Load at | 6.43 | 6.44 | 100.2% | 6.32 | 98.3% |
| 200% strain | | | | | |
| (N) | | | | | |
| Load at | 7.54 | 7.53 | 99.9% | 7.41 | 98.3% |
| 300% strain | | | | | |
| (N) | | | | | |
| Load at | 9.47 | 9.49 | 100.2% | 9.31 | 98.3% |
| 400% strain | | | | | |
| (N) | | | | | |
| Load at | 12.65 | 12.68 | 100.2% | 12.45 | 98.4% |
| 500% strain | | | | | |
| (N) | | | | | |

Specimen width = 50.8 mm.
Specimen length = 25.4 mm.
“N” = Newtons

TABLE 4

| | | | Compared | | Compared | | Compared |
|---|---|---|---|---|---|---|---|
| | | | to | | to | | to |
| | Precursor | Rectangular | precursor | Staggered | precursor | Overlapping | precursor |
| | film | array | film | array | film | array | film |
| Peak load (N) | 53.9 | 42.6 | 79.0% | 46.4 | 86.1% | 41.7 | 77.4% |
| Strain at break | 870 | 765 | 87.9% | 801 | 92.1% | 767 | 88.2% |
| (%) | | | | | | | |
| Load at 5% | 2.35 | 2.18 | 92.8% | 2.19 | 93.2% | 2.10 | 89.4% |
| strain (N) | | | | | | | |
| Load at 10% | 3.81 | 3.62 | 95.0% | 3.64 | 95.5% | 3.53 | 92.7% |
| strain (N) | | | | | | | |
| Load at 15% | 4.52 | 4.36 | 96.5% | 4.37 | 96.7% | 4.28 | 94.7% |
| strain (N) | | | | | | | |
| Load at 50% | 5.60 | 5.49 | 98.0% | 5.48 | 97.9% | 5.40 | 96.4% |
| strain (N) | | | | | | | |
| Load at 100% | 5.90 | 5.81 | 98.5% | 5.81 | 98.5% | 5.73 | 97.1% |
| strain (N) | | | | | | | |
| Load at 200% | 6.60 | 6.53 | 98.9% | 6.54 | 99.1% | 6.45 | 97.7% |
| strain (N) | | | | | | | |
| Load at 300% | 7.98 | 7.95 | 99.6% | 7.95 | 99.6% | 7.83 | 98.1% |
| strain (N) | | | | | | | |
| Load at 400% | 10.52 | 10.56 | 100.4% | 10.54 | 100.2% | 10.37 | 98.6% |
| strain (N) | | | | | | | |
| Load at 500% | 15.19 | 15.35 | 101.1% | 15.3 | 100.7% | 15.01 | 98.8% |
| strain (N) | | | | | | | |

Specimen width = 50.8 mm.
Specimen length = 31.75 mm.
“N” = Newtons.

TABLE 5

| | | | Compared | | Compared |
|---|---|---|---|---|---|
| | | | to | | to |
| | Precursor | | precursor | | precursor |
| | film | Short slits | film | Long slits | film |
| Peak load | 27.2 | 22.6 | 83.1% | 25.1 | 92.3% |
| (N) | | | | | |
| Strain at | 949 | 850 | 89.6% | 895 | 94.3% |
| break (%) | | | | | |
| Load at 5% | 1.07 | 1.09 | 101.9% | 1.07 | 100.0% |
| strain (N) | | | | | |
| Load at 10% | 1.79 | 1.77 | 98.9% | 1.76 | 98.3% |
| strain (N) | | | | | |
| Load at 15% | 2.15 | 2.12 | 98.6% | 2.12 | 98.6% |
| strain (N) | | | | | |
| Load at 50% | 2.72 | 2.67 | 98.2% | 2.68 | 98.5% |
| strain (N) | | | | | |
| Load at 100 | 2.86 | 2.83 | 99.0% | 2.84 | 99.3% |
| % strain (N) | | | | | |
| Load at 200 | 3.17 | 3.13 | 98.7% | 3.14 | 99.1% |
| % strain (N) | | | | | |
| Load at 300 | 3.73 | 3.71 | 99.5% | 3.73 | 100.0% |
| % strain (N) | | | | | |
| Load at 400 | 4.74 | 4.71 | 99.4% | 4.74 | 100.0% |
| % strain (N) | | | | | |
| Load at 500 | 6.49 | 6.49 | 100.0% | 6.53 | 100.6% |
| % strain (N) | | | | | |

Specimen width = 25.4 mm.
Specimen length = 50.8 mm.
“N” = Newtons.

It will be seen from the tables 3 to 5 that there is very little, if any, loss in load bearing ability in slit films when compared to the precursor unslitted film. In other words, addition of the slits does not adversely impact the tensile strength or hysteresis properties of the web.

In certain embodiments, the load at 50% or more elongation of the web is at least about 95% of the load of the unslitted precursor film at the same elongation. In still another embodiment, the peak load of the web is at least about 75% of the peak load of the unslitted precursor film. In yet another embodiment, the elongation at peak load of the web is at least about 85% of the elongation at peak load of the unslitted precursor film.

### Porosity Testing

Porosity testing was performed on a Textest FX 3300 (Advanced Testing Instruments Corp., SC) equipped with a 20 cm² orifice with a test pressure of 125 Pa. Porosity was tested at sample extensions of 0%, 50%, 100%, 150% and 200% for examples of slit elastic film, with slit patterns as noted in the table. The base film consisted of a tri-layer co-extruded film with a 2.4 mils thick core comprising a styrene block copolymer with skins 0.165 mils thick comprising low density polyethylene, linear low density polyethylene and isotactic polypropylene. Table 6 provides porosity data from three representative slit patterns.

For comparative purposes, a vacuum apertured elastic film also was tested under identical conditions and the results are provided in table 7. The vacuum apertured elastic film was a tri-layer co-extruded film with a 2.8 mils thick core comprising a styrene block copolymer with skins 0.165 mils thick comprising low density polyethylene and linear low density polyethylene.

TABLE 6

| | Porosity (m³/m²/min) | | | | |
|---|---|---|---|---|---|
| | Extension = | Extension = | Extension = | Extension = | Extension = |
| Slit Pattern | 0% | 50% | 100% | 150% | 200% |
| 2.5 mm/1.0/0.0/0.5 | 0.6 | 13.0 | 33.4 | 39.1 | 42.1 |
| 2.5 mm/0.67/0.0/0.5 | 0.4 | 9.0 | 19.7 | 24.3 | 31.3 |
| 2.5 mm/2.0/0.0/0.5 | 0.3 | 4.2 | 14.7 | 17.8 | 18.6 |

TABLE 7

| | Porosity (m³/m²/min) | | | | |
|---|---|---|---|---|---|
| | Extension = | Extension = | Extension = | Extension = | Extension = |
| | 0% | 50% | 100% | 150% | 200% |
| Vacuum | 24.6 | 6.1 | 0.8 | 0.4 | 0.2 |
| apertured film | | | | | |

From tables 6 and 7 it can be seen that whereas the porosity of the slit arrays increases when the film is placed under increasing tension, the vacuum apertured film porosity actually decreases, to the point that it could be considered to be no longer breathable. The slit pattern 2.5 mm/1.0/0.0/0.5 represents a preferred embodiment in that it is believed to maximize the porosity available for the structure.

### Neck-In Testing

Dimensional stability under stress of an elastomer film is an important consideration in choosing a film for a given application. Dimensional stability may be judged by measuring the neck-in of a film. Neck-in is the tendency of the film to narrow when placed under a tensile stress.

Neck-in testing was performed on a tensile tester equipped with line grips set for 1.0 inch gauge width (model Synergie 200 from MTS, Eden Prairie, Minn.). Two slitted array elastomer (SAE) films manufactured as described in Table 8 below, were tested against a flat film and a vacuum formed elastomer (VFE) film. One inch wide specimens of film as noted in the table were drawn to 200% extension at 10 in/minute. While stretched, the width of the sample at its narrowest point was measured directly with a ruler to the nearest 0.5 mm. Three specimens from each sample were measured and the mean value reported in Table 9. The neck-in value was calculated to the nearest whole percent using the following equation:

$$\text{Neck-in (\%)} = \frac{( 25.4 - \text{Observed width (mm)} )}{25.4} \times 100$$

TABLE 8

| Sample | Description |
|---|---|
| A | Unapertured film. Core = 2.8 mil film from |
| Flat Film | GLS 253-128 resin, skins = 0.1 mil 75% |
| | Dowlex 2517/25% ExxonMobil LD 202.48. Total |
| | gauge 3.0 mil. Made using a screen having 8% |
| | open area ILA (Increased Land Area) with |
| | minimal vacuum. |
| B | Similar to A but with a vacuum of 14.3 inches |
| VFE Film | of mercury to create holes. |
| C | Slit pattern 5.0 mm/0.5/0.0/0.5 cut into A |
| Slit Array Film | with slits parallel with the transverse direction. |
| D | Slit pattern 5.0 mm/05/−0.2/0.5 cut into A |
| Slit Array Film | with slits parallel with the transverse direction. |

TABLE 9

| Sample | Mean necked width (mm) | Calculated neck-in (%) |
|---|---|---|
| A | 17.13 | 33 |
| Flat Film | | |
| B | 17.50 | 31 |
| VFE Film | | |
| C | 18.87 | 26 |
| Slit Array Film | | |
| 5.0 mm/0.5/0.0/0.5 | | |
| D | 21.13 | 17 |
| Slit Array Film | | |
| 5.0 mm/0.5/−0.2/0.5 | | |

As can be seen in Table 9, the VFE film had a slightly reduced neck-in percentage compared to the flat film. Both SAE films had substantially reduced neck-in percentages relative to the VFE and flat films. Also, the SAE with the higher slit density (slits/square inch) showed less neck-in than the SAE with the lower slit density. The SAE films therefore exhibited greater dimensional stability than did the VFE and flat films. In one embodiment, the neck-in at 200% elongation of the web is no more than about 30%. In another embodiment, the neck-in at 200% elongation of the web is no more than about 29%. In another embodiment, the neck-in at 200% elongation of the web is no more than about 28%. In yet another embodiment, the neck-in at 200% elongation of the web is no more than about 27%, and more preferably, no more than about 26%.

### Additional Hysteresis Testing

The precursor film into which slits were cut was prepared from the same materials as Sample A in Table 8:

| | |
|---|---|
| Core: | 2.8 mil GLO resin from GLS, 253-128 |
| Skins: | 0.1 mil 75% Dowlex 2517/25% ExxonMobil |
| | LD202.48 |
| Total film thickness: | 3.0 mil |

The slit Array patterns were cut to match the “Staggered array” and “Overlapping chisel cut array” from Table 1 above. The slits were cut in either the machine direction (MD) or transverse direction (TD).

| | |
|---|---|
| Staggered array | 5.08 mm/1.0/0.0/0.5 |
| Overlapping chisel cut array | 6.0 mm/0.85/−0.15/0.5 |

Testing was performed under the conditions specified above with respect to the hysteresis testing. All samples were tested in the machine direction (MD) and transverse direction (TD—direction perpendicular to the common direction). The results can be found in Table 10 below. Two specimens were tested for each of the slit array films, and the average is reported in Table 10.

TABLE 10

| | | Staggered array | | Overlapping chisel cut | |
|---|---|---|---|---|---|
| | Precursor | 5.08 | | array | |
| | film | mm/1.0/0.0/0.5 | | 6.0 mm/0.85/−0.15/0.5 | |
| Slit orientation | NA | MD | TD | MD | TD |
| Number of | 3 | 2 | 1* | 2 | 2 |
| specimens reported | | | | | |
| Load at 200% | 10.18 | 10.01 | 3.95 | 10.51 | 2.42 |
| strain cycle 1 (N) | | | | | |
| Load at 30% strain | 1.12 | 1.36 | 0.24 | 1.12 | 0.11 |
| upon recovery | | | | | |
| cycle 2 (N) | | | | | |
| Force relaxation | 8.9 | 7.8 | 13.0 | 8.7 | 9.2 |
| during cycle 2 hold | | | | | |
| (%) | | | | | |
| Set cycle 2 (%) | 8.5 | 7.1 | 8.2 | 8.9 | 13.1 |

*The second specimen failed prematurely due to stress concentration at the tips of the slits

The unload ratio in the transverse direction range from about 0.21 to about 0.10, whereas the unload ratio in the machine direction, (i.e., the common direction of the slits), ranged from about 1.0 to about 1.21. Thus, apertured and slitted webs described in the literature, whose apertures and slits are designed to open when subjected to a tensile force in a direction transverse to the common direction, have significantly decreased unload force, when compared to the identical unslitted web. The webs described herein therefore retain much more of the desirable properties of the precursor unslitted elastic web than comparable webs designed to open apertures when subjected to transverse loads.

The properties of the slit array samples with slits cut parallel with the machine direction closely matched those of the precursor (unslit) film. The properties of the slit array samples with slits cut parallel with the transverse direction exhibited a significant loss of properties relative to the precursor (unslit) film. In particular, the load at 200% strain fell by more than 50% and the load at 30% strain upon recovery plummeted by more than 75%.

The utility of the embodiments can be expanded to form a composite material by lamination of the elastic web to other webs, and in particular nonwoven materials that can impart softness and loft. Lamination of webs can be achieved by several methods. Suitable methods include, but are not limited to, vacuum lamination, adhesive lamination, and thermal lamination. Webs that are bonded to the slitted web of this invention may be referred to as “secondary webs,” however, it is to be understood that this expression in fact includes the case where only one secondary web is bonded to the elastic web.

In one embodiment, a composite material comprises the web, wherein the web is bonded to one or both surfaces by a bonding mechanism to one or more secondary webs. In another embodiment, the composite material comprises the web bonded to a secondary web, wherein the secondary web comprises a nonwoven fabric. Preferably, the secondary webs are nonwoven fabrics that are extensible in a common direction of the stretchable web. In another embodiment, the composite materials are bonded by bonding means comprising vacuum lamination and adhesive lamination.

While the examples of the embodiments presented above have been limited to certain sizes and configurations of slits and regions of slits, it is recognized that similar advantages can be obtained by other sizes and configurations of slits and regions of slits. Those skilled in the art will recognize that various changes and modifications can be made to the various embodiments without departing from the spirit and scope thereof. All such modifications are within the scope of the embodiments.

1. A slitted stretchable web comprising a top surface and a bottom surface, the web comprising one or more regions having a plurality of slits, wherein:
i. each slit connects the top surface to the bottom surface;
ii. the slits are characterized by a major and a minor axes and are aligned with their major axes oriented at an angle within 45° of a common direction on the web surface;
iii. the slits open when a tensile force is applied to the web along the common direction;
iv. the slitted stretchable web has an unload force ratio of greater than about 0.25; and
v. the slitted stretchable web exhibits at least one feature selected from the group consisting of:
(a) neck-in at 200% elongation of no more than about 30%;
(b) peak load of at least about 75% of the peak load of the same web in an unslitted condition;
(c) elongation at peak load of at least about 85% of the elongation at peak load of the same web in an unslitted condition; and
(d) load at 50% or more elongation of at least about 95% of the load of the same web in an unslitted condition at the same elongation.

2. The web of claim 1 wherein the ratio of the major to minor axes (aspect ratio) of the slits is more than about 25.

3. The web of claim 1 wherein the slits are aligned each with their major axes oriented at an angle within 15° of a common direction on the web surface.

4. The web of claim 1 wherein the slits are positioned randomly within any one or more of said regions in the web.

5. The web of claim 1 wherein the arrangement of slits within any one or more of said regions is organized in an array, the array comprising rows of slits that are essentially parallel in their major axes.

6. The web of claim 5 wherein the array has a hexagonal symmetry such that the relative row offset value RO=SS/2, where SS is the relative slit separation.

7. The web of claim 5 wherein the array has a rectangular symmetry such that the relative row offset value RO=0 (zero).

8. The web of claim 5 wherein the array has a staggered configuration such that the relative row offset value RO is not equal to SS/2, where SS is the relative slit separation.

9. The web of claim 5 wherein the value of the relative row separation of the array RS is between about −0.9 and about 10.0.

10. The web of claim 5 wherein the relative row offset value of RO is less than about 0.5.

11. The web of claim 1 wherein the number density of slits per square inch within any one or more of the regions is between about 5 and about 1,000.

12. The web of claim 1 wherein the total length of slits per square inch within any one or more of the regions is between about 0.5 and about 50 inches/square inch.

13. The web of claim 1, wherein the web has an open area of from about 1% to about 15%, when stretched to 100% elongation.

14. The web of claim 1, wherein the unload force ratio is greater than about 0.6.

15. An article comprising the web of claim 1, the article selected from the group consisting of absorbent articles, disposable diapers, elastic bandages, incontinence articles, sanitary articles, protective apparel, medical drapes, and carpal tunnel bandages, wherein when the article is an absorbent article, the web forms at least a portion of a side panel or connection tab.

16. The article of claim 15, wherein the web forms at least a portion of a component of the article that is subjected to more than 20% elongation during normal use.

17. A composite material comprising the web of claim 1 bonded to a secondary web.

18. The composite material of claim 17 wherein the secondary web comprises a nonwoven fabric.

19. The composite material of claim 17 wherein the webs are bonded either by vacuum lamination or by adhesive lamination.

20. The composite material of claim 17 wherein the secondary web is a nonwoven fabric that is extensible in a common direction of the stretchable web.
